(19) United States
(12) Patent Application Publication
(10) Pub. No.: US 2010/0283361 A1
(43) Pub. Date: Nov. 11, 2010

(54) STORAGE CABINET WITH KEY AND ELECTRONIC KEY

(75) Inventors: Akihiro Sato, Seki-shi (JP); Nobuhiko Segi, Motosu-shi (JP)

Correspondence Address: OLIFF & BERRIDGE, PLC, P.O. BOX 320850, ALEXANDRIA, VA, 22320-4850, US

(73) Assignee: TOKAI RIKEN CO., LTD., Seki-shi (JP)

(21) Appl. No.: 12/734,135

(22) PCT Filed: Oct. 29, 2008
(86) PCT No.: PCT/JP2008/069592

§ 371 Date: Apr. 13, 2010

(30) Foreign Application Priority Data
Oct. 30, 2007 (JP) 2007-281921

(51) Int. Cl. E05B 47/00; A47B 81/00

(52) U.S. Cl. 312/222; 70/280

(57) ABSTRACT

A storage cabinet with key is provided with an electronic key having an electronic key ID memory means that stores electronic key ID, a storage box that stores an item to be kept, an opening and closing permission means that permits opening and closing of storage boxes, and an opening and closing control means that, when it reads out the electronic key ID and authenticates the right, makes the opening and closing permission means permit opening and closing of the storage boxes. The electronic key checks individual identification information input by one or more buttons arranged at the electronic key with specific individual identification information registered at an individual identification information memory means arranged at the electronic key.

### TECHNICAL FIELD

The present invention relates to a storage cabinet with key and an electronic key to permit opening and closing a door when authentication of authority is successful based on data stored in the electronic key.

### BACKGROUND ART

In offices, conventionally, keys for opening and closing corresponding storage boxes of each storage cabinet are stored in a key management box. In using one of the keys, a user opens a door of the key management box after authentication using an ID card or the like and takes out a key to a storage box the user intends to use. The key management box permits the door to be opened only when the user is ID-authenticated with the ID card and has the access right for the subject storage box.

However, it is troublesome to separately bring the ID card and the key. When a user wants to check or get documents in many storage boxes, the user has to bring around many keys. This is poor in working efficiency. To solve such problems, there is a demand for a system capable of opening and closing a plurality of storage boxes by use of one same key.

As the system for opening and closing storage boxes of a plurality of storage cabinets by using the same single key, a master key has been known. The master key is able to open and close all the storage cabinets but it is intended for emergency, e.g., if any individual key is lost. If the master key is daily used, it is meaningless to provide different locks to different storage boxes to keep stored articles or items. Furthermore, it is impossible to set an access right for each storage box to each person.

In this regard, there is a commercially available configuration using replaceable cylinder locks so that different locks are set in different storage boxes and some of the storage boxes are permitted to be opened and closed with a single key. For easily changing a relation between a cylinder lock and a key, there is an electronic key configured by a combination of an IC chip and a key. Accordingly, some storage boxes permitted to be opened and closed by a single electronic key are arbitrarily set and changed. The electronic key is harder to be duplicated and hence provides higher security as compared with a mechanical key.

However, even though an electronic key ensures high security, in case the electronic key itself is stolen, a storage box is allowed to be easily opened. Therefore, a storage cabinet system capable of validating and invalidating the electronic key is disclosed in Patent Literatures 1, 2, 3, and 4.

FIG. 18 is a view to schematically explain a storage cabinet system 100 disclosed in Patent Literature 1.

The conventional storage cabinet system 100 has the following configuration. When an electronic key 103 is put close to an electronic lock device 102 of a “storage cabinet with key” (hereinafter, a “storage cabinet”) 101 and authentication of authority is successful, an electronic lock 105 attached to a door 104 of the storage cabinet 101 is locked or unlocked.

A password setting device 106 is provided separately from the storage cabinet 101. For instance, a user locks the electronic lock 105 of the door 104 and then moves from the storage cabinet 101 to the password setting device 106 and invalidates the electronic key 103 by use of the password setting device 106. Even when the electronic key 103 is stolen, therefore, the door 104 cannot be unlocked. On the other hand, the user sets the electronic key 103 in a valid state by use of the password setting device 106 and then moves from the password setting device 106 to the storage cabinet 101 and puts the electronic key 103 near to the electronic lock device 102. The electronic lock 105 of the door 104 is unlocked.

As another example, Patent Literature 2 discloses the following configuration. Fingerprint data is read by a fingerprint reader. An electronic lock (key) removably inserted in an electronic lock body checks the fingerprint data read by the fingerprint data reader against fingerprint data registered in the electronic lock. Only when both data match each other, the electronic lock body permits the electronic lock to rotate. Such technique of Patent Literature 2 can prevent unauthorized or malicious use of the key without permission of an owner of the key or the like.

As another example, Patent Literature 3 discloses the following configuration. While an electronic key is stored in an electronic key issuing box, the electronic key performs two-way communications with the electronic key issuing box to register an identification code for authentication. According to Patent Literature 3, when the electronic key is inserted in a lock of a door of a safe, a controller of the safe reads the identification code for authentication from the electronic key and judges whether it coincides with an own individual identification code. If both codes are judged to coincide with each other, a cover lock covering a key hole of the safe is unlocked, permitting uncovering of the key hole. Patent Literature 3 further discloses that, when the cover lock is unlocked, a user moves the cover lock to a retract position and inserts a different key from the electronic key in the key hole to unlock the safe. The technique of Patent Literature 3 can lock and unlock the safe only when the authentication of authority is successful based on the fingerprint data registered in the electronic key.

As another example, Patent Literature 4 discloses the following configuration. An electronic key is provided with a fingerprint authenticating section for authenticating a fingerprint of a user and an open/close button for transmitting an open/close command to a safe or the like in non-contact relation. When the fingerprint authentication section achieves successful authentication using the user's fingerprint, the operation of the open/close button is validated. The invention disclosed in Patent Literature 4 can open and close the safe or the like by only a user whose fingerprint is registered in the electronic key.

### CITATION LIST

### Patent Literature

Patent Literature 1: JP 2004-251059 A

Patent Literature 2: JP 2005-90049 A

Patent Literature 3: JP 2004-360239 A

Patent Literature 4: JP 2006-188941 A

### SUMMARY OF INVENTION

### Technical Problem

However, according to the storage cabinet system 100 of Patent Literature 1, for instance, the user has to go to the password setting device 106 within an available time and validate or invalidate the electronic key 103. This is low in usability and the electronic key 103 could not ensure inherent security.

Specifically, if the user has no much time after he/she locks the electronic lock 105 with the electronic key 103 or if the user forget to invalidate the electronic key 103 and comes out, the user has to carry the electronic key 103 remaining valid with him/her. This lowers security of the electronic key 103.

For instance, if a user goes back to the storage cabinet 101 while carrying the electronic key 103 having been invalidated, the user could not unlock the electronic lock 105 to open the door 104. Thus, the user has to go to the password setting device 106 and validate the electronic key 103, and then go back to the storage cabinet 101 again. This causes time loss.

The storage cabinet system 100 of Patent Literature 1 mentioned above has restrictions in validating and invalidating the electronic key 103. Therefore there are problems with ensuring of inherent security and convenience of the electronic key 103.

In this regard, according to the techniques of Patent Literatures 2 and 4, the authentication of authority is performed based on the fingerprint on the electronic key. When authentication is successful, the electronic key is validated to lock and unlock the door. Validating and invalidating the electronic key have no positional limitation. However, in the techniques of Patent Literatures 2 and 4, the fingerprint reader for reading fingerprint and the board configuration are large and complicated. This needs a large electronic key.

In the technique of Patent Literature 3, the electronic key issuing box registers the identification code for authentication in the electronic key to validate the electronic key. Accordingly, when the electronic key is stolen or the like after it is brought out of the electronic key issuing box, the storage cabinet may be opened and closed maliciously.

The present invention has been made to solve the above problems and has a purpose to provide a storage cabinet with key and an electronic key capable of simply validating and invalidating the electronic key on the electronic key, thereby achieving a compact electronic key and enhancing security and usability.

### Solution to Problem

To achieve the above purpose, a storage cabinet with key and an electronic key according to the invention have the following configurations.

(1) One aspect of the invention provides a storage cabinet with key comprising: an electronic key including an electronic key ID memory means for storing an electronic key ID; a storage box for storing an item to be kept; an opening and closing permission means for permitting opening and closing of the storage box; and an opening and closing control means for causing the opening and closing permission means to permit opening and closing of the storage box when the control means reads the electronic key ID and authenticates an authority thereof, wherein the electronic key includes: one or more than two buttons for inputting personal identification information to identify an owner of the electronic key; a personal identification information memory means for registering a specific personal identification information; and an electronic key validating and invalidating means for checking the personal identification information input by the buttons against the specific personal identification information registered in the personal identification information memory means, and validating the electronic key when the input personal identification information is consistent with the registered personal identification information or invalidating the electronic key when the input personal identification information is inconsistent with the registered personal identification information.

It is to be noted that the button may include any buttons operable by being pressed or rotated on the electronic key, such as a jog dial button, as well as a button.

(2) In the invention described in (1), preferably, the electronic key validating and invalidating means includes: a validity condition determining means for determining whether or not a valid period of time or a valid number of times to maintain a valid state of the electronic key is over; and an electronic key access permitting means for permitting access to the electronic key ID memory means when the validity condition determining means determines that the valid period of time or the valid number of times is not over.

(3) In the invention described in (1) or (2), preferably, internal data of the electronic key is rewritten by a mobile terminal connected to a host computer through a communication line.

(4) An electronic key of another aspect of the invention is used in the storage cabinet with key set forth in one of (1) to (3).

(5) Another aspect of the invention provides an electronic key containing an IC chip, the electronic key comprising: one or more than two buttons for inputting personal identification information to identify an owner of the electronic key; a personal identification information memory means for registering a specific personal identification information; and an electronic key validating and invalidating means for checking the personal identification information input by the buttons against the specific personal identification information registered in the personal identification information memory means, and validating the electronic key when the input personal identification information is consistent with the registered personal identification information or invalidating the electronic key when the input personal identification information is inconsistent with the registered personal identification information.

### ADVANTAGEOUS EFFECTS OF INVENTION

In the storage cabinet with key and the electronic key of the invention having the above configurations, the personal identification information input in one or two buttons is checked against the specific personal identification information stored in the personal identification information memory means. When the input personal identification information coincides with the registered personal identification information, the electronic key is validated and permitted to open and close the storage box of the storage cabinet. When the input personal identification information does not coincide with the registered personal identification information, the electronic key is invalidated and disabled to open and close the storage box of the storage cabinet.

The above electronic key of the invention is validated by personal authentication performed based on the personal identification information input with one or more than two buttons on the electronic key. Accordingly, the electronic key does not need to include a large reading part and a complicated substrate for reading the personal identification information such as fingerprint and thus the electronic key is compact. The electronic key of the invention has no positional limit and time limit for validating or invalidating and hence the electronic key is convenient. Furthermore, even when the electronic key of the invention is dropped or lost, the electronic key cannot be validated to open and close the storage cabinet unless proper personal identification information is input with one or more than two buttons. Security therefore can be enhanced.

According to the storage cabinet with key and the electronic key to be used therein of the invention, the electronic key is validated based on the valid period of time or the number of times the key can be validated. Even if the electronic key once validated is automatically invalidated at the time when the valid period of time or the valid number of times is over. The electronic key is thus disabled to open and close the storage box of the storage cabinet. Consequently, the storage cabinet with key and the electronic key to be used therein of the invention can prevent unauthorized use of the electronic key by an unauthorized person.

Furthermore, according to the storage cabinet with key and the electronic key to be used therein of the invention, the electronic key is connected to a mobile terminal which is connected to a host computer through a communication line, so that data of the electronic key can be rewritten by the host computer. The storage cabinet with key and the electronic key to be used therein of the invention can have no limitations of time and place to rewrite the data of the electronic key.

### BRIEF DESCRIPTION OF DRAWINGS

FIG. 1 is a perspective external view of a storage cabinet with key in a first embodiment of the invention;

FIG. 2 is an electrical block diagram of a lock control means shown in FIG. 1;

FIG. 3 is a plan view of an electronic key of FIG. 1;

FIG. 4 is a view of the electronic key seen from a direction A in FIG. 3;

FIG. 5 is a view of an internal structure of the electronic key of FIG. 3;

FIG. 6 is a sectional view of a case shown in FIG. 3;

FIG. 7 is a block diagram showing a read/write circuit of the electronic key of FIG. 3;

FIG. 8 is a logical block diagram of the electronic key of FIG. 3;

FIG. 9 is a view showing an example of a data rewriting system for rewriting access right to be stored in an electronic key in a second embodiment of the invention;

FIG. 10 is a view to explain operations of the data rewriting system of FIG. 9;

FIG. 11 is a view showing an example of a configuration for connecting the electronic key to a personal computer in a third embodiment of the invention;

FIG. 12 is a view showing a data rewriting processing of the electronic key of FIG. 11;

FIG. 13 is a schematic configuration view of a key management box for managing electronic keys in a fourth embodiment of the invention;

FIG. 14 shows a first modified example of the electronic key of FIG. 1;

FIG. 15 shows a second modified example of the electronic key of FIG. 1;

FIG. 16 shows a third modified example of the electronic key of FIG. 1;

FIG. 17 is a view showing a modified example of an electronic circuit of the electronic key of FIG. 1; and

FIG. 18 is a view to schematically explain an electronic lock type locker system disclosed in Patent Literature 1.

### REFERENCE SIGNS LIST

1 Electronic key
7 Command button
8a, 8b First and Second setting input buttons
13 Contact IC chip
20 Lock (opening/closing permission means)
22 Personal authentication means
22a Personal identification information discriminating means
22b Personal identification information memory means
22c Personal identification information input means
23 Validity condition determining means
24 Electronic key access permission control means
25 Electronic key ID memory means
28 Electronic key validating/invalidating means
40 Lock control means (opening/closing control means)
51, 42, 53 Storage cabinet with key
51A, 52A, 52B, 52C, 52D, 53A, 53B, 53D Storage box
71 Cell phone (Mobile terminal)
77 Network (Communication line)
78 Host computer
92 External communication interface
95 Personal computer (Rewriting device)

### DESCRIPTION OF EMBODIMENTS

A detailed description of a preferred embodiment of a “storage cabinet with key” (hereinafter, also simply referred to as a “storage cabinet”) and an electronic key to be used therein embodying the present invention will now be given referring to the accompanying drawings.

### First Embodiment

### Entire Configuration of Storage Cabinet with Key

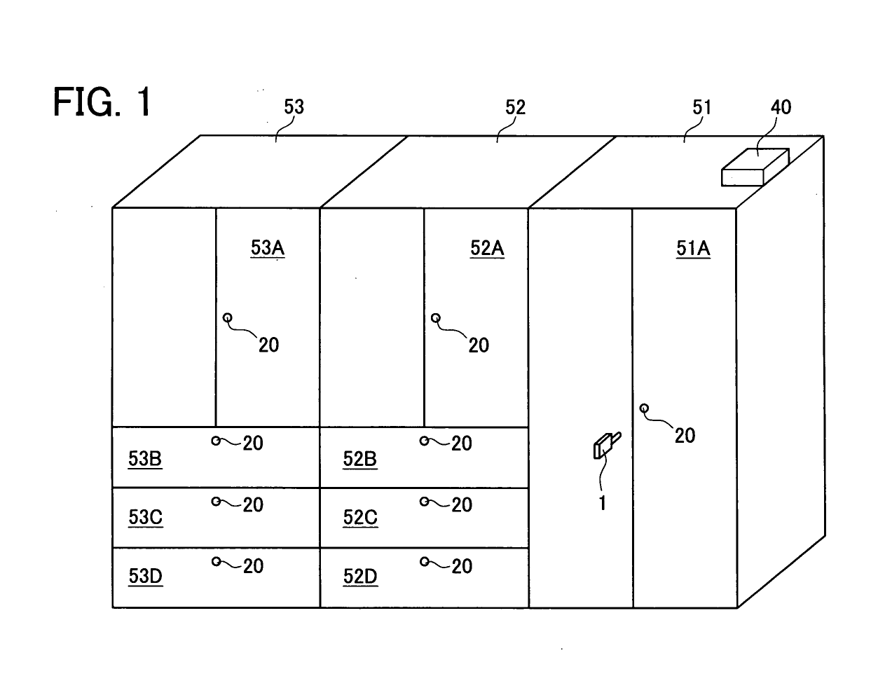

FIG. 1 is an external perspective view of storage cabinets with key 51, 52, and 53 in a first embodiment of the invention.

In the first embodiment, three types of storage cabinets 51, 52, and 53 are placed contiguously. The storage cabinet 51 includes a double-doored storage box 51A. The storage cabinet 52 includes one double-doored storage box 52A and three drawer storage boxes 52B, 52C, and 52D. The storage cabinet 53 is identical in structure to the storage cabinet 52. Each of the storage boxes 51A, 52A, 52B, 52C, 52D, 53A, 53B, 53C, and 53D is provided with a lock 20 (one example of “opening/closing permission means”) and can store therein an article(s) or item(s). On an upper surface of the storage cabinet 51, a lock control means 40 (one example of “opening and closing control means”) is placed to control opening and closing of each of the storage boxes 51A, 52A, 52B, 52C, 52D, 53A, 53B, 53C, and 53D of three storage cabinets 51, 52, and 53.

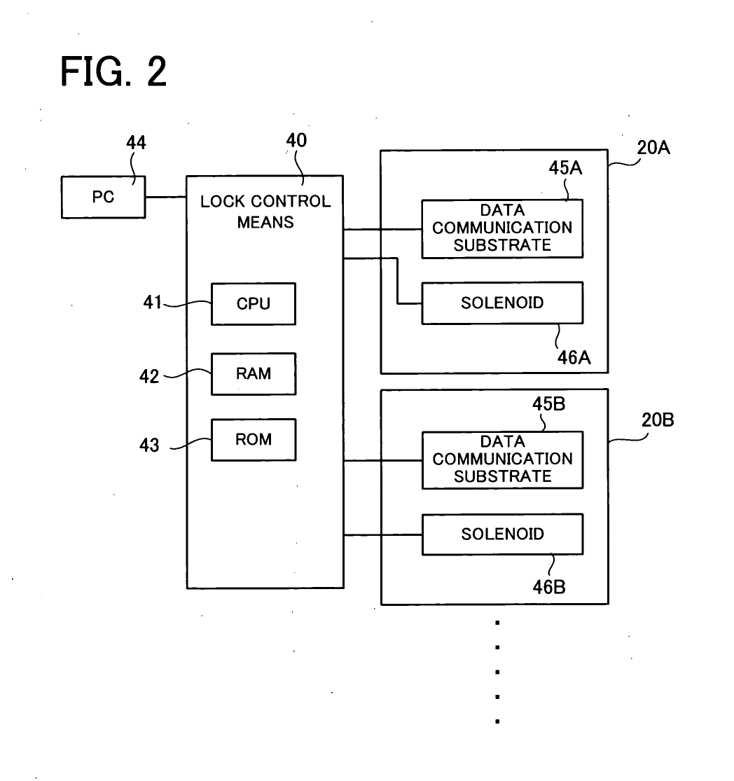

FIG. 2 is an electrical block diagram of the lock control means 40 shown in FIG. 1.

The lock control means 40 includes a CPU 41 for processing and calculating data, a ROM 43 for storing a control program, and a RAM 42 for reading and writing an opening/closing record or history of each storage box (which storage box was opened and closed by whom and when) and data of contact IC chips having access right to storage boxes. The lock control means 40 is linked with a personal computer (PC) 44 via LAN.

The personal computer 44 also stores the opening/closing record of each storage box as with the RAM 42 to enhance the safety of data. The personal computer 44 modifies the data in the RAM 42 when access right data is modified in association with the change of the access right to be given to a person, addition of a storage cabinet, and others. When the opening/closing record in the RAM 42 is rewritten, the personal computer 44 similarly modifies the opening/closing record stored in the personal computer 44.

Each of locks 20A, 20B, 20C, . . . includes a data communication substrate 45A, 45B, 45C, . . . for reading/writing data from/in the electronic key 1 and also a solenoid 46A, 46B, 46C, . . . for controlling rotation of each corresponding lock 20. The lock control means 40 is connected to the data communication substrates 45A, 45B, 45C, . . . and the solenoids 46A, 46B, 46C, . . . of the locks 20 respectively through wiring.

If the personal computer 44 is unusable, that is, when for example a low-cost standalone system is to be achieved, the lock control means 40 may be provided with a registration means such as a key switch. In this case, for instance, a person authorized to change the access right data enters a password with the key switch or the like to rewrite a mode to validate a registration function. In the mode of validating the registration function, when data of the contact IC chip is read out, the data is directly registered and stored in the RAM 42. Thus, the access right can be easily changed.

<Electronic Key>

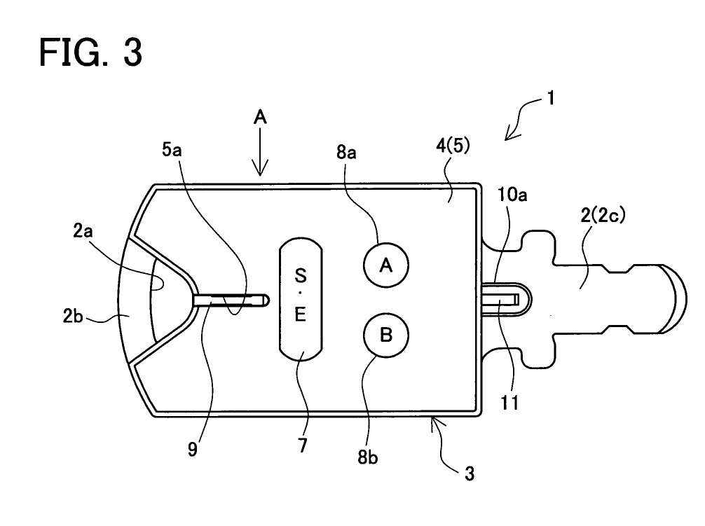

FIG. 3 is a plan view of the electronic key shown in FIG. 1. FIG. 4 is a side view seen from an arrow A in FIG. 3.

The electronic key 1 includes an IC unit 3 attached to a metal insert element 2. The IC unit 3 has an outer appearance made of a resin case 4 to prevent static electricity. The case 4 includes a first case part 5 and a second case part 6, between which a hollow part is formed to hold a frame portion 2b of the insert element 2.

A command button 7 for commanding the start and the end of input operation and setting input buttons 8 (a first setting input button 8a and a second setting input button 8b in the first embodiment) for inputting “personal identification information” are provided to be exposed to the outside of the first case part 5 so that they are pushed and operated. An LED 9 is placed to be exposed to the outside from an opening 5a formed in the first case part 5 so that a blinking state of the LED 9 is visible. In the IC unit 3, a first terminal 11 and a second terminal 12 of the IC chip 13 are placed to extend from the inside to the outside of the case 4 and arranged on both sides of the insert element 2.

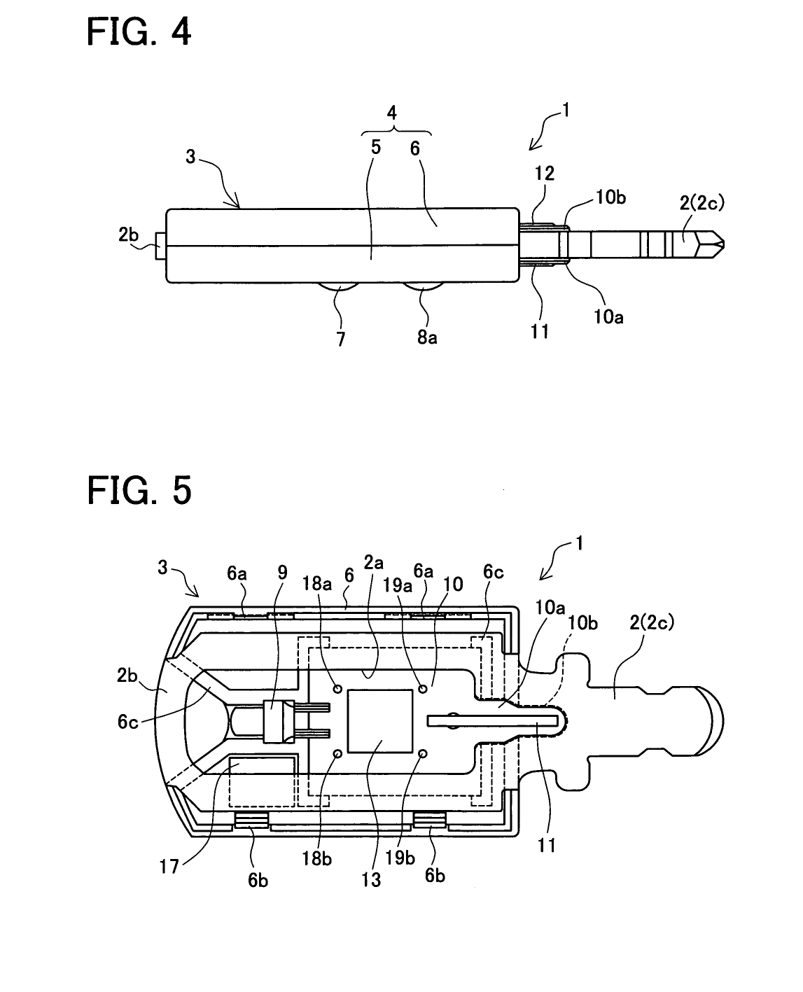

FIG. 5 is a view showing an internal structure of the electronic key 1 shown in FIG. 3.

A frame portion 2b of the insert element 2 integrally includes an insert portion 2c protruding out of the case 4. The frame portion 2b is formed with an opening 2a in which the IC chip 13 mounted on a IC chip substrate 10 and the LED 9 are placed, thereby preventing wirings of the IC chip 13 and the LED 9 from touching the insert element 2. On the substrate 10, the IC chip 13, the first terminal 11 and the second terminal 12 of the IC chip 13, and the LED 9 are fixed by soldering or the like. The substrate 10 is provided with a first command input contact point 18a for outputting an input start command signal to the IC chip 13 when the contact point 18a comes into contact with a start command contact (not shown) built in one end of the command button 7, a second command input contact point 18b for outputting an input end signal to the IC chip 13 when the contact point 18b comes into contact with an end command contact (not shown) built in the other end of the command button 7, and setting input contact points 19a and 19b for outputting a signal A or a signal B to the IC chip 13 when the contact point 19a or 19b comes into contact with a contact (not shown) built in the first setting input button 8a or the second setting input button 8b. The substrate 10 includes extended portions 10a and 10b arranged in parallel and spaced at a predetermined interval. The first and second terminals 11 and 12 are mounted on the extended portions 10a and 10b respectively and insulated from the insert element 2.

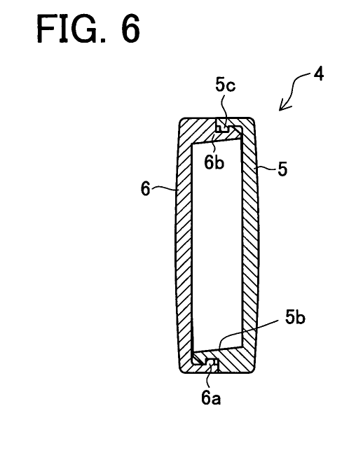

FIG. 6 is a sectional view of the case 4 of FIG. 3.

In the case 4, each of the first and second case parts 5 and 6 has an angular U shape in section. The first and second case parts 5 and 6 are connected in such a way that a hooked claw 5b of the first case part 5 is engaged with a protrusion 6a of the second case part 6 while a hooked claw 6b of the second case part 6 is engaged with a protrusion 5c of the first case part 5.

Herein, the case 4 is hollow and thus the substrate 10 is liable to be displaced. The case 4 is therefore configured as shown in FIG. 5 such that a rib 6c is provided in vertical position on the inner side of the second case part 6 to surround the substrate 10 and the LED 9, so that the substrate 10 and the LED 9 are held between the rib 6c and the insert element 2. It is to be noted that the formation of the rib 6c produces a clearance between the second case part 6 and the frame part 2b of the insert element 2. In that clearance, a battery 17 serving as a power source of the IC chip 13 is placed.

<Electrical Circuit Configuration of Electronic Key>

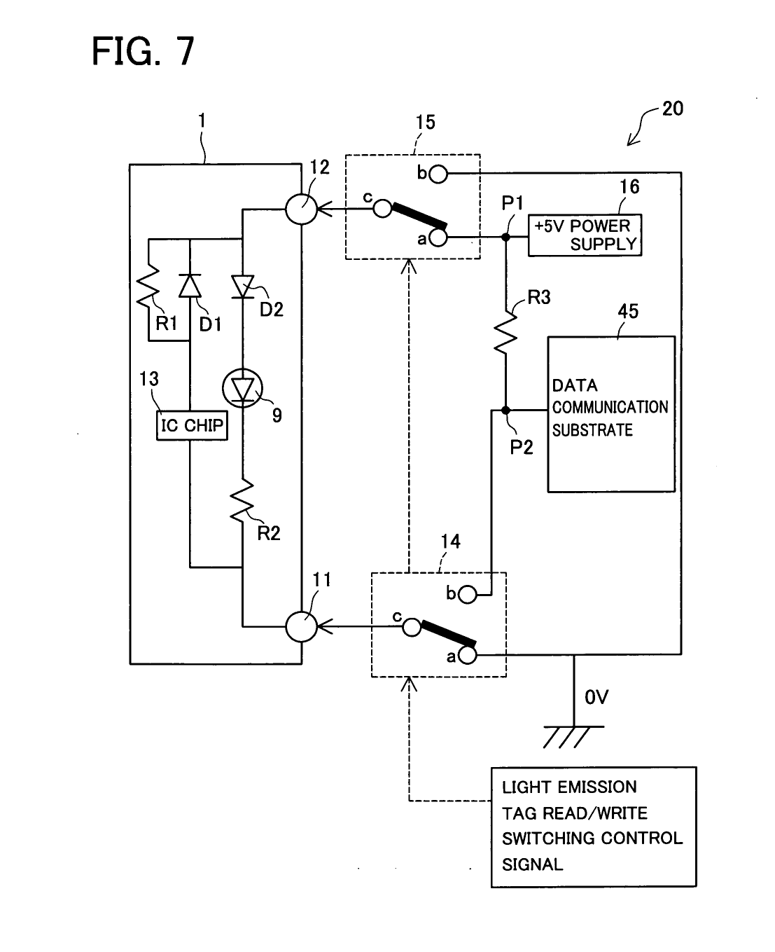

FIG. 7 is a block diagram showing a read/write circuit of the electronic key 1 of FIG. 3.

In the electronic key 1, a first rectifier diode D1 has an anode coupled to the IC chip 13 and a cathode coupled to the first terminal 11 to allow a current to flow from the first terminal 11 to the second terminal 12. A first resistor R1 is arranged in parallel with the first rectifier diode D1. Even when a slight current flows in the contact IC chip 13 which is a nonlinear element, accordingly, the first rectifier diode D1 is switched to an ON state.

In the electronic key 1, the LED 9 is arranged in parallel with the contact IC chip 13. A second rectifier diode D2 has an anode coupled to the second terminal 12 and a cathode coupled to the LED 9 to allow a current to flow from the second terminal 12 to the first terminal 11. A second resistor R2 is arranged between the LED 9 and the second terminal 12 to stabilize the current flowing in the LED 9. The first and second rectifier diodes D1 and D2 and the first and second resistors R1 and R2 constitute a “circuit switching means” for switching between a circuit for supplying a current to the IC chip 13 and a circuit for supplying a current to the LED 9.

<Logical Block Configuration of Electronic Key>

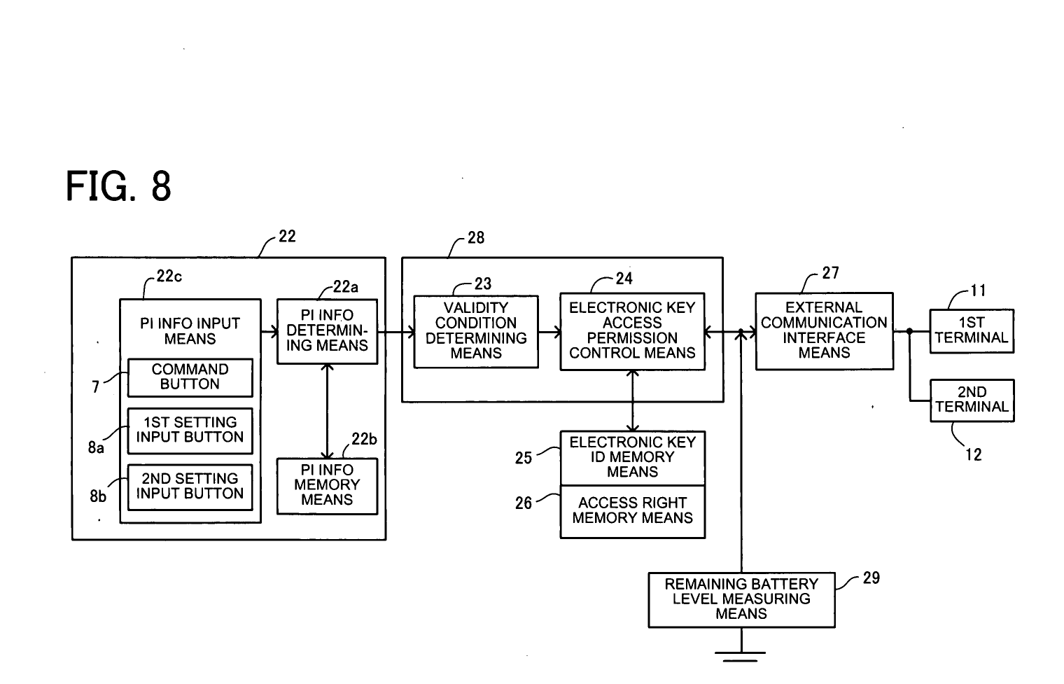

FIG. 8 is a logical block diagram of the electronic key 1 of FIG. 3.

The electronic key 1 includes a personal authentication means 22, a means 28 for validating/invalidating the electronic key, and an external communication interface means 27.

The personal authentication means 22 is configured to personally authenticate an owner of the electronic key 1. The personal authentication means 22 includes a personal identification (PI) information input means 22c, a personal identification (PI) information determining means 22a, and a personal identification (PI) information memory means 22b.

The PI information input means 22c is configured to enter “personal identification (PI) information”. The “PI information” is data to identify a person who has a proper right to use the electronic key 1. In the first embodiment, the PI information input means 22c is constituted of the command button 7 and the first and second setting input buttons 8a and 8b.

The PI information memory means 22b is configured to register “PI information” previously registered when the electronic key 1 is assigned (hereinafter, referred to as “registered PI information” to distinguish from the “PI information” input by the PI information input means 22c). The “PI information” stored in the PI information memory means 22b can be rewritten only by a rewrite dedicated device designed only for rewriting data of an electronic key 1 (e.g., a personal computer installed with a rewrite dedicated software) to ensure high security.

The PI information determining means 22a is configured to compare the “PI information” input by the input means 22c with the registered PI information in the PI information memory means 22b and authenticates the “PI information” when both informations coincide with each other.

The electronic key validating/invalidating means 28 is configured to validate the electronic key 1 when the personal authentication means 22 authenticates the “PI information” but invalidate the electronic key 1 when the personal authentication means 22 does not authenticate the “PI information”. This electronic key validating/invalidating means 28 includes a validity condition determining means 23 and an electronic key access permission control means 24.

The validity condition determining means 23 determines whether or not a “validity condition” is satisfied when the personal authentication means 22 authenticates the “PI information”. The “validity condition” represents a condition for maintaining the validity of the electronic key 1. The “validity condition” is preferably a valid period and the valid number of times in which the electronic key 1 can be used in order to prevent anyone else to improperly or maliciously use the electronic key 1. When the “validity condition” is the valid period, the validity condition determining means 23 is a timer. On the other hand, when the “validity condition” is the valid number of times, the validity condition determining means 23 is a counter. In the first embodiment, the “validity condition” is set as the valid period for which the electronic key 1 is valid only for five minutes after the “PI information” is input by the PI information input means 22c and hence the validity condition determining means 23 is the timer.

The electronic key access permission control means 24 normally breaks a circuit for connecting the first and second terminals 11 and 12. When the validity condition determining means 23 determines that the “validity condition” is satisfied, that is, that it is within 5 minutes from the input of the “PI information” by the PI information input means 22c, the electronic key access permission control means 24 connects the first and second terminals 11 and 12 and permits the external communication interface means 27 to access electronic key ID memory means 25 and access right memory means 26.

The electronic key ID memory means 25 is configured to store an “electronic key ID” for identifying the electronic key 1. The “electronic key ID” in the memory means 25 can be rewritten only by the rewriting dedicated device for rewriting data of the electronic key 1 (e.g., the personal computer installed with the rewriting dedicated software). The memory means 25 may be configured to store, as the electronic key ID, the number assigned to the IC chip 13 when manufactured.

The access right memory means 26 is configured to store the “access right” an owner of the electronic key 1 has. The “access right” represents a right of opening and closing the storage box(s). An authorized person to set and change access rights installs a software to rewrite access rights in an own personal computer and individually change the access rights stored in the access right memory means 26.

The external communication interface means 27 is configured to come into contact with the first and second terminals 11 and 12 to control the communications with a data reading means (e.g., the lock control means 40) for reading and writing data in or from the IC chip 13.

A remaining battery level measuring means 29 is connected between the access permission control means 24 and the external communication interface means 27. This measuring means 29 is arranged to monitor a remaining level of the battery 17 and blink the LED 9 at specific intervals in case the remaining level of the battery 17 decreases below a predetermined level to inform a user that the battery remaining level is low.

<Electrical Block Configuration of Lock>

As shown in FIG. 7, the lock 20 includes a first switch circuit 14 and a second switch circuit 15 connectable with the first and second terminals 11 and 12 of the electronic key 1 respectively to read the data from the electronic key 1. The first and second switch circuits 14 and 15 constitute a “polarity switching means” for switching the polarities of the first and second terminals 11 and 12 of the IC chip 13 when the polarity switching means is connected to the first and second terminals 11 and 12 to thereby read the data of the IC chip 13 and supply electric current to the LED 9.

The first and second switch circuits 14 and 15 are configured to selectively connect respective contacts “c” to contacts “a” or “b”. The contact “a” of the first switching circuit 14 and the contact “b” of the second switching circuit 15 are connected to ground. On the other hand, the contact “a” of the second switching circuit 15 is connected to a power supply 16. The contact “b” of the first switching circuit 14 is coupled to a data communication substrate 45. A pull-up resistor R3 is connected to a contact P1 between the contact “a” of the second terminal and the power supply 16 and also to a contact P2 between the contact “b” of the first switch circuit 14 and the data communication substrate 45 in order to stabilize the voltage at 5V to be applied from the power supply 16 to the first switching circuit 14 or the second switching circuit 15.

Accordingly, when the contact “c” in the first switch circuit 14 is connected to the contact “a” thereof and the contact “c” of the second switch circuit 15 is connected to the contact “b” thereof, both the first and second terminals 11 and 12 are grounded. Thus, no current is supplied to the first and second terminals 11 and 12. In other words, the data reading from the IC chip 13 and the lightening of the LED 9 are not conducted. When the contacts “c” of both the first and second switch circuits 14 and 15 are connected to respective contacts “a”, the power supply 16 is connected to ground through the second switch circuit 15, the second terminal 12, the LED 9, the first terminal 11, and the first switch circuit 14. In the electronic key 1, accordingly, a current flows from the second terminal 12 to the first terminal 11 through the LED 9, thereby lighting up the LED 9. On the other hand, when the contacts “c” of both the first and second switch circuits 14 and 15 are connected to respective contacts “b”, the power supply 16 is connected to ground through the data communication substrate 45, the first switch circuit 14, the first terminal 11, the IC chip 13, the second terminal 12, and the second switch circuit 15. In the electronic key 1, therefore, a current flows from the first terminal 11 to the second terminal 12 through the IC chip 13. Thus, the lock control means 40 (see FIG. 2) reads the data from the IC chip 13 through the data communication substrate 45. In the present embodiment, when the first and second switch circuits 14 and 15 switch respective contact connections as above, the direction of the current flowing in the first and second terminals 11 and 12 is reversed, thereby changing the polarities of the first and second terminals 11 and 12.

<Explanation of Operations>

The following explanation will be given to the operations of the storage cabinets 51, 52, and 53 and the electronic key 1 to be used therein.

A person authorized to set and change the access rights stores for example an access right to access the storage boxes 51A, 52A, and 53A in the access right memory means 26 of the electronic key 1 and gives that electronic key 1 to a person (user) X.

When the person X intends to take out a document(s) or file(s), the person X goes to the storage cabinet 52 and inserts the validated electronic key 1 in the lock 20 of the storage box 52A. Validating the electronic key 1 will be mentioned later.

In the electronic key 1, the LED 9 is lit up and the electronic key ID and the access right in the IC chip 13 are read by the first and second switch circuits 14 and 15 of the lock 20. This data communication method will be mentioned later.

In the lock 20, the data communication substrate 45 outputs the electronic key ID and the access right read from the electronic key 1 through the first and second switch circuits 14 and 15, to the lock control means 40. The lock control means 40 checks the electronic key ID and the access right read by the data communication substrate 45 against the data stored in the RAM 42. If the right of use of the storage box 52A is authenticated, a voltage is applied to the solenoid 46 in the lock 20 of the storage box 52A to permit the rotation of the lock 20. When hears a driving sound of the solenoid 46, the person X turns the electronic key 1 in a predetermined direction to unlock the lock 20.

The person X opens the door of the storage box 52A, takes out a desired document(s) or file(s), and closes the door of the storage box 52A. The person X then turns the electronic key 1 in a reverse direction to the predetermined direction until the person X hears a click sound, locking the lock 20.

At that time, the control means 40 stores the date and time the person X unlocks the lock 20, as the date and time at which the person X opens the storage box 52A, in the RAM 42 and the personal computer 44. The lock control means 40 also stores the date and time the person X locks the lock 20, as the date and time at which the person X closes the storage box 52A, in the RAM 42 and the personal computer 44. Furthermore, the IC chip 13 of the electronic key 1 also stores a usage history of the storage box 52A.

If the person X forgets to lock the lock 20, it is possible to specify that the person X who opened the storage box 52A did not close the door of the storage box 52A from the usage history of the RAM 42 of the lock control means 40 and the personal computer 44. To responsibly open and close the storage box 52A, therefore, the person X must reliably lock the storage box 52A. This prevents the person X from forgetting to lock or wrongly locking the storage box 52A.

When the person X intends to return the file(s) or document(s) to the storage box 52A, the person X has only to open and close the storage box 52A in the same sequence as above and returns the file(s) or document(s). In this case, the date and time the person X opened and closed the storage box 52A is also stored in the lock control means 40, the personal computer 44, and the electronic key 1.

<Validating of Electronic Key>

The person X validates the electronic key 1 in the following manner.

The person X pushes the command button 7 of the electronic key 1 to command the start of inputting the “PI information”, and then, for example, pushes the first setting input button 8a three times to enter “A” three times, pushes the second setting input button 8b once to enter “B” once, thereby inputting a set of “PI information” (A-A-A-B). Subsequently, the person X pushes the command button 7 again to terminate the input of the “PI information”.

In the electronic key 1, the PI information determining means 22a checks the input “PI information” against the registered PI information in the PI information memory means 22b and determines whether or not both PI informations coincide with each other. When both PI informations are consistent with each other, the validity condition determining means 23 is activated to determine whether or not it is within a valid period (5 minutes) from the input of the “PI information”. If it is within the valid period (5 minutes), the electronic key access permission control means 24 connects the first and second terminals 11 and 12 to permit the external communication interface means 27 to access the electronic key ID memory means 25 and the access right memory means 26.

After a lapse of the valid period (5 minutes) from the time the person X inputs the “PI information”, the validity condition determining means 23 of the electronic key 1 determines that the validity condition is not satisfied. In this case, the electronic key access permission control means 24 cuts off the circuit connecting the first and second terminal 11 and 12 not to permit the external communication interface means 27 to access the electronic key ID memory means 25 and the access right memory means 26. Thus, the electronic key 1 is automatically invalidated.

For instance, if the “registered PI information” is A-A-B-B, the “PI information” (A-A-A-B) input as above is inconsistent with the registered PI information. In this case, the validity condition determining means 23 does not operate and the electronic key access permission means 24 continues to break the circuit for connecting the first and second terminal 11 and 12. Thus, the electronic key 1 remains invalid. In such a case, the electronic key 1 is validated when the person X inputs correct “PI information” again.

<Data Communication Method>

The person X inserts the electronic key 1 in the lock 20 so that the first terminal 11 and the second terminal 12 of the electronic key 1 come into contact with the contacts “c” of the first switch circuit 14 and the second switch circuit 15 of the lock 20. At that time, the lock control means 40 of the lock 20 outputs a control signal to the first and second switch circuits 14 and 15 to bring the contacts “c” into contact with the contacts “a” in the first and second switch circuits 14 and 15. If the electronic key 1 is valid, a current from the power supply 16 flows from the second switch circuit 15 to the first switch circuit 14 through the electronic key 1.

In the validated electronic key 1, the current supplied through the second switch circuit 15 is fed to the LED 9 through the second rectifier diode D2, thus turning on the LED 9. At that time, the current supplied through the second switch circuit 15 does not flow in the IC chip 13 by the first rectifier diode D1.

After a lapse of a predetermined time (e.g., several milliseconds), the first and second switch circuits 14 and 15 switch respective contact connections to bring the contact “c” into contact with the contact “b”. The power supply 16 thus supplies a current to the electronic key 1 through the first switch circuit 14. The current supplied to the electronic key 1 flows in the IC chip 13 and further flows in the second switch circuit 15 through the first rectifier diode D1.

In this state, the data communication substrate 45 electrically connects with the IC chip 13 through the first switch circuit 14. While the electronic key 1 has been validated by the electronic key validating/invalidating means 28, the lock control means 40 can read the “electronic key ID” and the “access right” from the electronic key ID memory means 25 and the access right memory means 26 of the IC chip 13 through the data communication substrate 45. The lock control means 40 can store the date and time at which the storage box 52A is opened and closed in a memory of the IC chip 13 through the data communication substrate 45. After a lapse of a predetermined time (e.g., several milliseconds), the lock control means 40 outputs a control signal to the first and second switch circuits 14 and 15 to bring the contacts “c” into contact with the contacts “a”.

Herein, the lock control means 40 repeats switching of the contacts of the first and second switch circuits 14 and 15 for as short as several milliseconds. Accordingly, the LED 9 appears to the eyes of the person X to remain lit by persistence of vision. The person X can confirm from the lighting state of the LED 9 that the data of the IC chip 13 is being read into the storage cabinet side.

On the other hand, for instance, when the person X inserts the electronic key 1 in the lock 20 of the storage box 52A even though the person X has forgotten to input the “PI information” or when the valid period of the electronic key 1 has elapsed, the access permission control means 24 of the electronic key 1 breaks the circuit connecting the first and second terminals 11 and 12. Thus, the external communication interface 27 is not allowed to access to the electronic key IC memory means 25 and the access right memory means 26. In the storage cabinet 52A, the data substrate 45 cannot read the “electronic key ID” and the “access right” from the electronic key ID memory means 25 and the access right memory means 26 of the IC chip 13 and does not unlock the lock 20 of the storage box 52A. Thus, the data communication substrate 45 cannot store the date and time at which the storage box 52A is opened and closed in the memory of the IC chip 13.

In the above case, the connection between the first and second terminals 11 and 12 is cut off by the electronic key access permission control means 24, so that no current flows between the first and second terminals 11 and 12. Thus, the LED 9 of the electronic key 1 does not light up. The person X looks at the unlit LED 9 and finds that the lock 20 is not permitted to be unlocked because the electronic key 1 is in an invalid state. The person X then removes the electronic key 1 from the lock 20 and inputs the “PI information” to validate the electronic key 1, and then inserts the electronic key 1 in the lock 20 of the storage box 52A again.

In the case where the LED 9 is not lit up even after the electronic key 1 is validated or in the case where the LED 9 blinks irregularly, the person X considers that contact failures occur at the first and second terminals 11 and 12. This may be caused by oxide films generated on the first and second terminals 11 and 12, because such oxide films cause unstable currents to flow in the first and second terminals 11 and 12. In this case, the person X has to repeat insertion and removal of the electronic key 1 with respect to the lock 20 to eliminate the oxide films from the first and second terminals 11 and 12. When the lock 20 comes unlocked, the person X opens the storage box 52A and takes out an item or article stored therein.

Furthermore, in the case where the person X inserts the electronic key 1 in the lock 20 of the storage box 52B which the person X is authorized to open and close, the electronic key ID and the access right of the IC chip 13 of the electronic key 1 are read by the lock control means 40 through the data communication substrate 45 of the lock 20. However, authentication is failed and thus the person X cannot open and close the storage box 52B. In this case, the lock control means 40 brings the contact “c” into contact with the contact “a” in each of the first and second switch circuits 14 and 15 to light up the LED 9 and then brings the contact “c” into contact with the contact “b” in each of the first and second switch circuits 14 and 15 for a very short period to read the data from the IC chip 13. When authentication is failed, the lock control means 40 brings the contact “c” into contact with the contact “a” in the first switch circuit 14 and brings the contact “c” into contact with the contact “b” in the second switch circuit 15 to light out the LED 9. This series of lighting-up of the LED 9, reading of data from the IC chip 13, and lighting-out of the LED 9 is repeated, so that the LED 9 appears to human eyes to blink at fixed intervals. Accordingly, the person X looks at the blinking LED 9 and finds authentication failure and hence reinserts the electronic key 1 in the lock 20 of the storage box 52A which the person X is authorized to open and close. Regarding the above storage cabinets 51 to 53, the electronic key 1 performs by itself personal authentication based on the information input by the buttons 7, 8A, and 8B and further the above storage cabinets 51 to 53 perform personal authentication by reading data from the electronic key 1 inserted in the lock 20. Thus, double personal authentication is performed for opening and closing of each storage box, achieving high security.

<Theft of Electronic Key>

Even if the electronic key 1 of the person X is stolen by a third person Y, the electronic key 1 remains invalid unless the “PI information” has not been entered and the “validity condition” has not been satisfied. Accordingly, even when the third person Y inserts the invalid electronic key 1 in the lock 20 of the storage box 52A, the data communication substrate 45 does not electrically contact with the IC chip 13 and the lock control means 40 does not apply a voltage to the solenoid 46 of the lock 20 of the storage box 52A, thus restricting the rotation of the lock 20. Thus, the third person Y cannot turn the electronic key 1 in the predetermined direction to unlock the lock 20 and hence cannot steal any file(s) or document(s) from the storage box 52A.

It is to be noted that the “PI information” is input in the electronic key 1 at the hand of the person X. As compared with the case where a password is input in an authentication device attached to each storage cabinet, therefore, the “PI information” is very unlikely to be stolen by a third person. Particularly, in the electronic key 1, the “PI information” is input by the order of pushes and the number of pushes of the first and second setting input buttons 8a and 8b. It is substantially impossible for a third person Z to input the same “PI information” in the electronic key 1 without being noticed by the person X. Consequently, the third person Y could not input the “PI information” of the person X in the stolen electronic key 1 to validate the electronic key 1.

<Lending of Electronic Key>

For instance, if the person X who is attending a meeting needs a file(s) stored in the storage box 52A placed in a separate room during the meeting, the person X lends the electronic key 1 validated by input of the “PI information” to a subordinate Z and asks him/her to bring the file(s) to this table.

When the subordinate Z inserts the electronic key 1 in the lock of the storage box 52A within the valid period (5 minutes) of the electronic key 1, the lock control means 40 authenticates the electronic key 1 and permits the rotation of the lock 20 of the storage box 52A. The subordinate Z turns the electronic key 1 in the predetermined direction, opens the storage box 52A, and takes out the file(s) designated by the person X. Then, the subordinate Z closes the door of the storage box 52A and turns the electronic key 1 in the reverse direction to the predetermined direction to lock the lock 20.

<Rewriting Data of Electronic Key>

For instance, when the owner of the electronic key 1 is to be changed from the person X to another person W, the electronic key 1 is sent to a manufacturer thereof. In the manufacturer, the “PI information” of the person X is deleted from the PI information memory means 22b by use of a rewriting dedicated device (not shown), rewrites the “PI information” of the person W in the PI information memory means 22b, and then sends the electronic key 1 to the person W.

Accordingly, the electronic key 1 cannot be validated even if the “PI information” of the person X is input and can serve as a private key for the person W.

<Sharing of Electronic Key>

In the case where a single electronic key 1 is shared among a plurality of persons, a person authorized to change data of the electronic key 1 or a key management box stores “access right” and “PI information” of a person (user) who needs the use of the electronic key 1 in the access right memory means 26 and the PI information memory means 22c respectively and permits the user to bring out the electronic key 1. The user of the electronic key 1 has only to input the “PI information” registered in the electronic key 1 with the command button 7 and the first and second setting input buttons 8a and 8b to thereby validate the electronic key 1 in the same manner as above to use the electronic key 1.

When the single electronic key 1 is shared among the plural persons as above, it is preferable to store usage history in the electronic key 1 at the time of use of a storage box, absorb the usage history from the electronic key 1 into the key management box to manage items or articles stored in the storage cabinets 51, 52, and 53 for enhancing security.

For security, it is also preferable to delete the “registered PI information” stored in the PI information memory means 22b from the returned electronic key 1.

### Operations and Advantages of First Embodiment

As explained above, according to the storage cabinets 51, 52, and 52 and the electronic key 1 available therein in the first embodiment, personal authentication is performed based on the PI information input with the command button 7 and the first and second setting input buttons 8a and 8b on the electronic key 1 and the electronic key 1 is validated. Accordingly, the storage cabinets 51, 52, and 52 and the electronic key 1 do not require any reading means and any complicated substrate for reading PI information such as fingerprints and therefore they are compact. The electronic key 1 in this embodiment has no positional limitation and no time limit for validating or invalidating and thus it is convenient. Furthermore, the electronic key 1 in this embodiment is configured such that, even if the electronic key 1 is lost, the electronic key 1 cannot be validated to open and close the storage boxes of the storage cabinets 51 to 53 unless proper PI information is input with the command button 7 and the first and second setting input buttons 8a and 8b. Thus, the electronic key 1 can achieve high security.

According to the storage cabinets 51, 52, and 53 and the electronic key 1 available therein in the first embodiment, personal authentication is performed by checking the “PI information” input with the PI information input means 22c (the command button 7 and the first and second setting input buttons 8a and 8b) of the key 1 against the “registered PI information” registered in the PI information memory means 22b of the key 1. Accordingly, the electronic key 1 can be easily validated or invalidated anytime.

According to the storage cabinets 51, 52, and 53 and the electronic key 1 available therein in the first embodiment, the electronic key 1 is validated based on the valid period set to maintain the valid state of the electronic key 1. Thus, even the electronic key 1 once validated is automatically invalidated at the time when the valid period has passed. Each storage box of the storage cabinets 51, 52, and 53 cannot be opened and closed with such electronic key 1. Consequently, the storage cabinets 51, 52, and 53 and the electronic key 1 available therein in the first embodiment can prevent any person unauthorized to use the electronic key 1 from using without restriction.

If the validity condition is the number of times, the number of times data is read from the IC chip of the electronic key 1 is counted and it is determined whether or not the electronic key 1 is used by the number of times in which the electronic key 1 is permitted to be used. After the electronic key 1 is used by the valid number of times and then invalidated to prevent any unauthorized person from using the electronic key 1 without restriction.

In the storage cabinets 51, 52, and 53 in the first embodiment, the polarities of the first and second terminals 11 and 12 of the electronic key 1 are changed to perform data reading from the contact IC chip 13 and lighting-up of the LED 9. The storage cabinets 51, 52, and 53 in the first embodiment can achieve a simple and compact circuitry and confirm from the lighting of the LED 9 that the first and second terminals 11 and 12 are normally made conductive to each other and the data is read from the IC chip 13.

In the storage cabinets 51, 52, and 53 in the first embodiment, furthermore, the first and second switch circuits 14 and 15 change the polarities of the first and second terminals 11 and 12 of the electronic key 1 based on the blinking signal generated by the LED 9. Accordingly, the circuits can be switched without needing an increase in the number of components, and at low cost.

### Second Embodiment

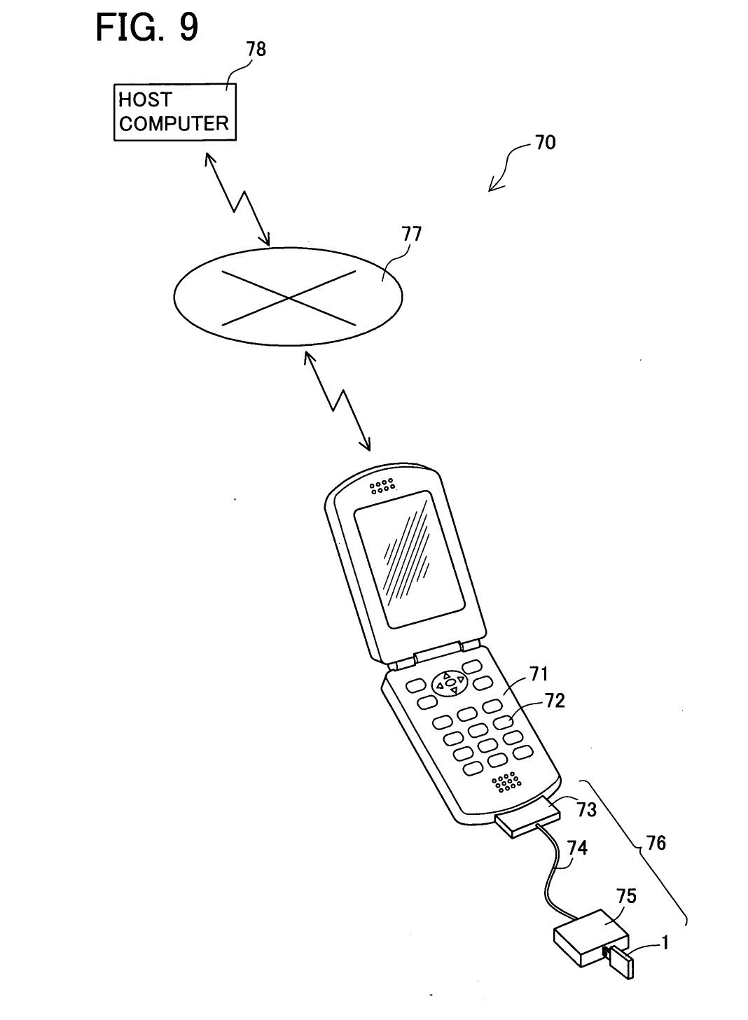

Next, a second embodiment of a storage cabinet with key (hereinafter, simply referred to as a “storage cabinet”) and an electronic key according to the invention will be explained. FIG. 9 is a view showing an example of a data rewriting system 70 for rewriting access right to be stored in the electronic key 1 in the second embodiment.

The storage cabinet(s) and the electronic key in the second embodiment are configured to connect the electronic key 1 to a host computer through a cell phone 71 which is an example of a “mobile terminal” and rewrite data (e.g., access right) of an IC chip 13. Herein, identical parts or components to those in the first embodiment are given the same reference signs and their details are not explained accordingly.

<Schematic Configuration of Data Rewriting System>

The data rewriting system 70 utilizes the cell phone 71. The cell phone 71 includes an operation part 72 and is connected with a connection control unit 76 connectable with the electronic key 1. The connection control unit 76 is arranged such that a first connector 73 to be connected to the cell phone 71, a second connector 75 internally containing a reader for reading the data from the electronic key 1 in contact with the first and second terminals 11 and 12, and a communication line 74 connecting the first and second connectors 74 and 75. The cell phone 71 is connected to a host computer 78 via a network 77. The network 77 is a network provided by a telecommunications company. The host computer 78 includes a data base for storing user's “PI information”, “electronic key ID”, and “access right” by associating them.

<Explanation of Operations>

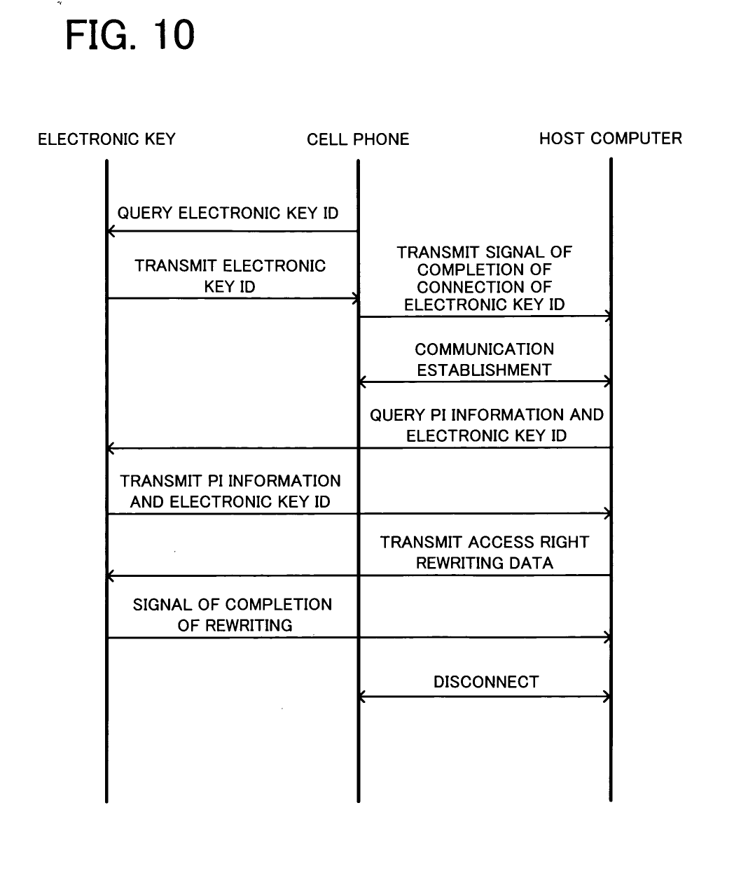

FIG. 10 is a view to explain the operations of the data rewriting system 70 shown in FIG. 9.

In the data rewriting system 70, when the communication control unit 76 is connected to the cell phone 71 and the electronic key 1 is inserted in the second connector 75, the cell phone 71 queries the electronic key 1 to find the electronic key ID. When the cell phone 71 obtains the electronic key ID from the electronic key 1, the cell phone 71 determines that communication with the electronic key 1 has been established. By operation of the operation part 72, the cell phone 71 is connected to the host computer 78 via the network 77. Then, the cell phone 71 transmits a signal representing completion of the connecting operation with the electronic key to the host computer 78.

Upon receipt of the signal representing completion of the connecting operation with the electronic key, the host computer 78 establishes the communication with the cell phone 71. In other words, the host computer 78 establishes the communication with the IC chip 13 of the electronic key 1 through the medium of the cell phone 71. Successively, the host computer 78 queries the IC chip 13 to find the “PI information” and the “electronic key ID”. The IC chip 13 reads the “PI information” from the PI information memory means 22b and the “electronic key ID” from the electronic key memory means 25 and then transmits them to the host computer 78.

The host computer 78 checks the “PI information” and the “electronic key ID” received from the electronic key 1 against the database and retrieves the “access right” corresponding to the “PI information” and the “electronic key ID” from the database. The retrieved “access right” is transmitted as “access right rewriting data” to the IC chip 13. The IC chip 13 overwrites the received “access right rewriting data” over the access right data in the access right memory means 26 to rewrite the “access right” data stored in the access right memory means 26. After completion of the rewriting, the IC chip 13 transmits a signal representing completion of the rewriting to the host computer 78. Upon receipt of the signal representing completion of the rewriting, the host computer 78 disconnects from the cell phone 71.

When the cell phone 71 is disconnected from the host computer 78, the connection control unit 76 disconnects the electronic key 1 from the cell phone 71.

In this embodiment, preferably, the second connector 75 contains a lock mechanism for locking the electronic key 1 while the IC chip 13 is connected to the host computer 78. This is to prevent the electronic key 1 from separating from the second connector 75 before completion of rewriting the access right in order to reliably rewrite the access right.

### Operations and Advantages of Storage Cabinet with Key in Second Embodiment

As above, according to the storage cabinet(s) with key and the electronic key 1 available therein in the second embodiment, the electronic key 1 is connected to the cell phone 71 and the cell phone 71 is connected to the host computer 78 via the network 77. The data (access right) of the electronic key 1 can be rewritten by the host computer 78. Consequently, the storage cabinet(s) with key and the electronic key 1 available therein in the second embodiment have no positional limitation and no time limit to rewrite the data of the electronic key 1.

The storage cabinet with key in the second embodiment utilizes the cell phone 71 widely available in recent years as the “mobile terminal”. Accordingly, it is unnecessary to ask a person who manages or keeps the electronic key 1 to rewrite the data of the electronic key 1. This eliminates time loss. When the system is to be adopted, no additional rewriting device is required. It is only necessary to pay usage fees of the network 77 to rewrite the data of the electronic key 1. Adoption of the data rewriting system 70 is realized at low cost.

The mobile terminal may be not only the cell phone 71 but also a PDA and others.

### Third Embodiment

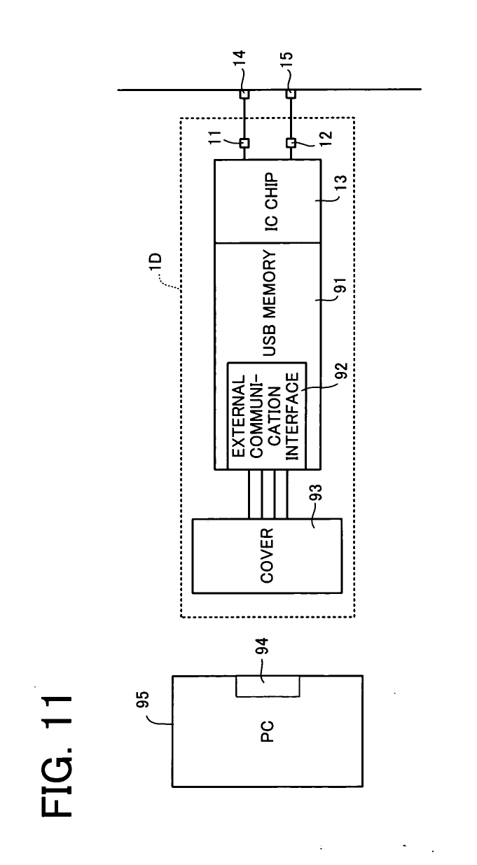

Next, a third embodiment of a storage cabinet with key (hereinafter, simply referred to as a “storage cabinet”) and an electronic key according to the invention will be explained. FIG. 11 is a view showing an example of a configuration for connecting an electronic key 1D to a personal computer 95 in the third embodiment.

According to the storage cabinet(s) and the electronic key 1D in the third embodiment, an external communication interface 92 is provided in the electronic key ID to control communication with a rewriting device for rewriting data stored in an IC chip 13 such as “access right”. Herein, the identical parts or components to those in the first embodiment are given the same reference signs and their details are not explained accordingly.

<Electronic Key>

As shown in FIG. 11, the electronic key 1D is configured to integrally connect the IC chip 13 to a commercially available USB memory 91 to additionally have the function of a storage medium. The electronic key 1D includes a cover 93 that covers the external communication interface 92 of the USB memory 91. The external communication interface 92 is connected to a USB port 94 of the personal computer 95 to control the communication with the personal computer 95. The personal computer 95 has installed with a rewriting program for rewriting data such as the “access right” stored in the IC chip 13 and serves as a rewriting device.

<Explanation of Operations>

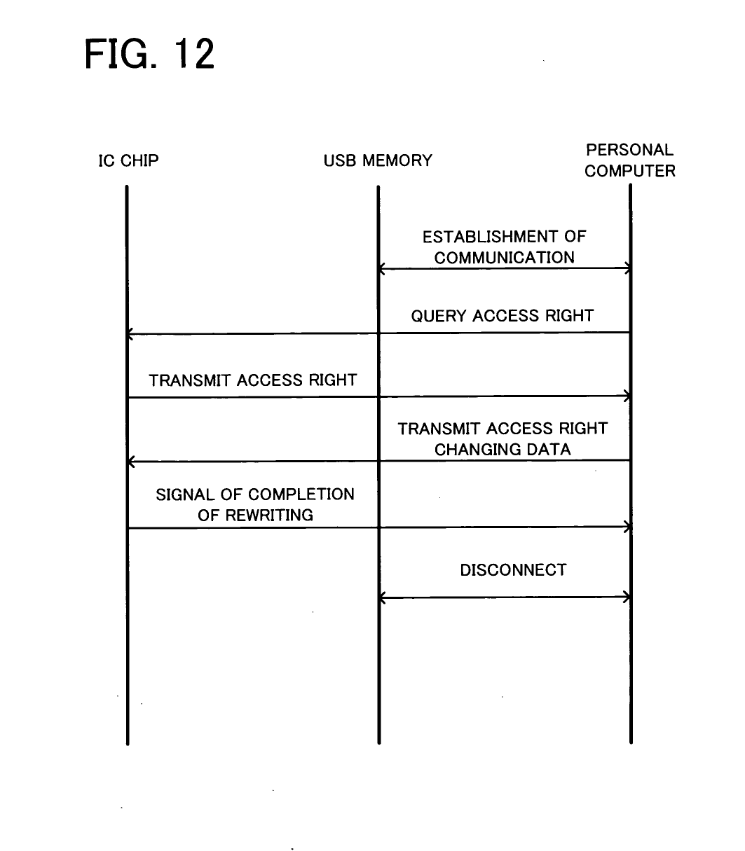

FIG. 12 is a view showing data rewriting processing of the electronic key 1D shown in FIG. 11.

When the “access right” of the electronic key 1D is to be rewritten, it is impossible to directly connect the first and second terminals 11 and 12 of the electronic key 1D to the personal computer 95 and establish communication between the IC chip 13 and the personal computer 95.

However, when the cover 93 is removed from the external communication interface 92 of the electronic key 1D and this interface 92 is connected to the USB port 94 of the personal computer 95, the personal computer 95 is connected to the IC chip 13 through the USB memory 91, thereby establishing the communication.

At the time when the communication with the IC chip 13 is established, the personal computer 95 triggers the rewriting program. The personal computer 95 determines whether or not the right of rewriting the “access right” exists based on a password, fingerprints, ID authentication, and others. If the rewriting right exists, the personal computer 95 queries the IC chip 13 to find the “access right”. The IC chip 13 retrieves the existing “access right” from the access right memory means 26 and transmits it to the personal computer 95. The personal computer 95 then displays on a screen the details of the “access right” received from the IC chip 13. When the details of the “access right” are changed with a keyboard or the like and a rewriting command is input, the personal computer 95 transmits the changed “access right” to the IC chip 13 as “access right changing data”.

The IC chip 13 overwrites the “access right changing data” over the access right data in the access right memory means 26 to rewrite the details of the “access right”. Upon completion of the rewriting, the IC chip 13 transmits a signal representing completion of the rewriting to the personal computer 95. Upon receipt of the signal representing completion of the rewriting, the personal computer 95 disconnects from the external communication interface 92 of the USB memory 91 to terminate the rewriting program. Thus, the IC chip 13 of the electronic key 1D is disconnected from the personal computer 95. The rewriting of the “access right” is completed.

If the personal computer 95 determines that there is no right of rewriting the “access right”, the personal computer 95 does not permit to change the details of the “access right”. Thus, the electronic key 1D cannot change the “access right” without authority.

### Operations and Advantages of Storage Cabinet with Key in Third Embodiment

As above, according to the storage cabinet(s) with key in the third embodiment, the “access right” of the electronic key 1D can be rewritten by connecting the external communication interface 92 of the electronic key 1D to the personal computer 95. Accordingly, the storage cabinet(s) with key in the third embodiment needs no rewriting dedicated device for rewriting data of the electronic key 1D and no additional communication means (wiring and others) for connecting to the rewriting device. Thus, the “access right” of the electronic key 1D can be rewritten inexpensively and easily.

The electronic key 1D may also be configured to allow stored data such as “PI information” and “electronic key ID” as well as the “access right” to be rewritten by the personal computer 95 by a person properly authorized to rewrite data.

### Fourth Embodiment

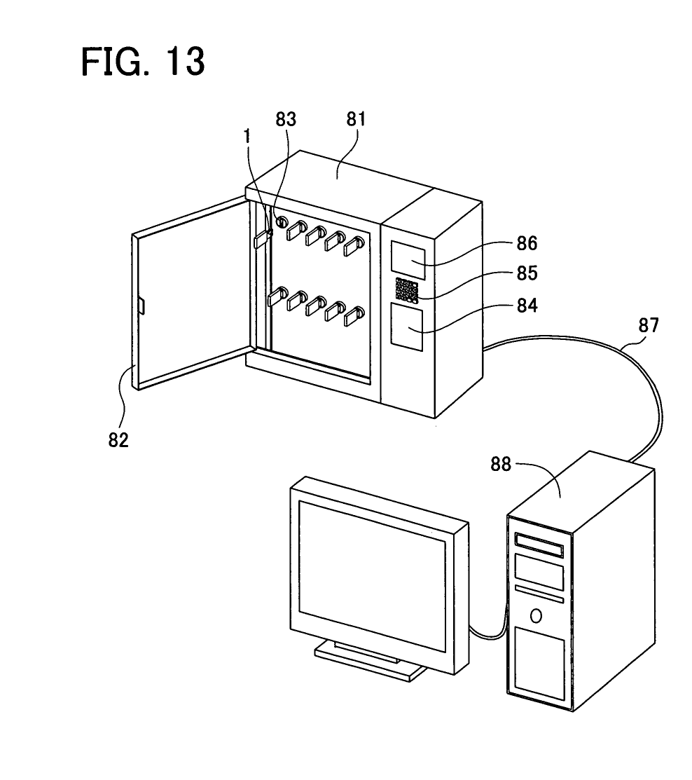

Next, a fourth embodiment of a storage cabinet with key (hereinafter, simply referred to as a “storage cabinet”) and an electronic key according to the invention will be explained. FIG. 13 is a schematic configuration view of a key management box 81 for managing an electronic key 1 in the fourth embodiment.

The storage cabinet(s) and the electronic key 1 in the fourth embodiment are different from those in the first embodiment in that the key management box 81 for managing the electronic key 1 also serves as a rewriting device for rewriting data of the electronic key 1 and “PI information” constituted of random numbers is registered in the electronic key 1 to be taken out of the box 81. Accordingly, the following explanations are focused on the differences from the first embodiment. Identical parts and components are given the same reference signs and their details are not explained here.

As shown in FIG. 13, the key management box 81 is provided with an open/close door 82 which is normally closed. Behind the door 82, the key management box 81 is formed with ten key holes 83 for holding electronic keys 1. The key management box 81 is provided with a card reader 84, a numeric keypad 85, and a liquid crystal display (LCD) 86. The key management box 81 is connected to a personal computer 88 through a communication line 87 so that the operations of the box 81 are controlled by the personal computer 88. The communication line 87 may be arranged to connect the key management box 81 and the personal computer 88 in one-to-one relation or to connect them via a network such as LAN. Each key hole 83 has a key retainer not shown to lock each electronic key 1 from being removed.

### Explanation of Operations

For instance, if a person X puts his/her employee ID card with a non-contact IC chip close to the card reader of the key management box 81, the card reader 84 communicates with the non-contact IC chip of the ID card. The non-contact IC chip has stored a “personal ID” individually assigned to identify an employee. The card reader 84 thus obtains the “personal ID” from the non-contact IC chip. The key management box 81 also displays a password entry screen on the LCD 86 to urge password entry in order to prevent anyone else from using the ID card for unauthorized activity of wrongdoing.

The personal computer 88 has stored the “personal ID” of an employee authorized to use the storage cabinet managing system in association with the “password” and the “access right”. When the “personal ID” read from the ID card coincides with the “personal ID” registered in the personal computer 88 and the password input with the numeric keypad 85 coincides with the password stored in the personal computer 88, the personal computer 88 transmits an unlock permitting signal to the key management box 81 to permit opening and closing of the door 82.

The personal computer 88 detects an operational state of the key retainer not shown provided in each key hole 83 and always grasps which key hole/holes 83 the electronic key/keys 1 is/are inserted in. The personal computer 88 specifies one of the electronic keys 1 inserted in the key holes 83 and initializes the IC chip 13 of the specified key 1 and then writes the “access right” and the “PI information” defined by random numbers in the IC chip 13 of the electronic key 1 through the key management box 81. The electronic key 1 in which the above data are written is a key assigned to the person X and authorized to open and close a specified storage box(s) (e.g., storage boxes 51A, 52A, and 53A).

Upon completion of the data writing, the personal computer 88 unlocks the key retainer not shown of the key hole 83 holding the specified electronic key 1. The personal computer 88 displays the location of the removable electronic key 1 and the “PI information” (e.g., A-B-A-A-B) written in the IC chip 13.

The person X has to memorize the “PI information” (e.g., A-B-A-A-B) appearing on the LCD 86. When the person X is to open the storage box 52A, the person X inputs the “PI information” in the electronic key 1 with the command button 7 and the first and second setting input buttons 8a and 8b to validate the electronic key 1. Validating of the electronic key 1 is performed in the same manner as in the first embodiment and the explanation thereof is not repeated.

The electronic key 1 is preferably configured to limit the number of inputs of the “PI information” in order to prevent the electronic key 1 from becoming validated by inputting the “PI information” again and again.

If the person X cannot recall the “PI information” or the number of inputs exceeds a predetermined value, the person X should go to the key management box 81 and returns the electronic key 1 therein, and then takes out the electronic key 1 therefrom again. Accordingly, the person X rememorizes another “PI information” reinput in the electronic key 1 appearing on the LCD 86 and hence can validate the electronic key 1.

### Operations and Advantages of Storage Cabinet with Key and Electronic Key in Fourth Embodiment

According to the storage cabinet(s) with key and the electronic key 1 in the fourth embodiment, the “PI information” set with random numbers is stored in the PI information memory means 22b when the electronic key 1 is to be taken out of the key management box 81. Accordingly, the “PI information” is changed every time the electronic key 1 is taken out of the key management box 81. When the person X returns the electronic key 1 to the key management box 81 before he/she leaves a firm or office, the “PI information” of the electronic key 1 is changed when the person X takes out the key 1 from the key management box 81 the next day. Accordingly, even if a third person steals the “PI information” by taking a surreptitious glance at hand motions of the person X operating the command button 7 and the first and second setting input buttons 8a and 8b and then the third person steals the electronic key 1 from the person X and inputs the “PI information” the next day, the electronic key 1 cannot be validated. According to the electronic key 1 in the fourth embodiment, consequently, even if the “PI information” is stolen, validating of the electronic key 1 is disabled, thus enhancing a security level.

### Fifth Embodiment

Next, a fifth embodiment of the invention will be explained.

The fifth embodiment is different from the fourth embodiment in that, a key management box utilizes biometric personal data (hereinafter, referred to as “biometric data”) to store an authority to open and close a storage box into an electronic key 1. Thus, the following explanations are focused on the differences from the first embodiment. Identical parts and components are not explained here accordingly.

The key management box is provided with a biometric data reading part for reading biometric data, instead of the card reader 84 shown in FIG. 13. In this embodiment, a fingerprint is one example of the biometric data. The key management box has registered in advance a user identification number(s) in association with the fingerprint(s) of a user(s) authorized to open and close the key management box.

When the biometric data of a user is read by the biometric data reading part, the key management box determines based on the biometric data as an argument whether or not the user is authorized to open and close the key management box. If the user has no authority to open and close, opening and closing of the key management box is not permitted. If the user has an authority to open and close, on the other hand, the read fingerprint and the user identification are stored in the contact IC chip 13 of the electronic key 1. The key management box is unlocked to permit the electronic key 1 to be taken out therefrom.

The user pushes the buttons 7, 8a, and 8b of the electronic key 1 to input PI information to validate the electronic key 1 and then inserts the electronic key 1 in a lock 20 of a target storage box. The lock control means 40 connected to the lock 20 has stored fingerprints and user identification informations of users authorized to open and close each storage box. The lock control means 40 checks the fingerprint and the user identification information read from the contact IC chip 13 against the fingerprint and the user identification information previously stored in correspondence with the relevant storage box having the lock in which the electronic key 1 is inserted. If either or both of the read fingerprint and the user identification information do not coincide with the registered fingerprint and the user identification information, the lock 20 is not permitted to rotate. In other words, opening and closing of the storage box is refused. On the other hand, if the read fingerprint and the user identification information coincide with the registered fingerprint and the user identification information, the lock 20 is permitted to rotate. That is, opening and closing of the storage box is permitted.

When the storage box is closed, usage history of the storage box is written in the contact IC chip 13 of the electronic key 1. The electronic key used as above is invalidated when the valid period or the valid number of times is over.

When the electronic key 1 is returned to a key hole 83 of the key management box, the fingerprint data and the usage history of the storage box stored in the contact IC chip 13 are absorbed into the key management box. The key management box specifies the user based on the absorbed fingerprint data as an argument and stores the usage history of the storage box.

When the electronic key 1 in the fifth embodiment is inserted in the lock 20 of the storage cabinet, authority authentication is performed based on the user identification information and the fingerprint, thus achieving high security of the storage cabinet.

Furthermore, the electronic key 1 stores the fingerprint data of the user. Accordingly, the storage cabinet does not need to include a fingerprint reading part and can be provided at low cost.

Even if the user loses the electronic key 1 storing his/her fingerprint data, the electronic key 1 cannot open and close any storage cabinet unless the key 1 is validated by input of the PI information with the buttons 7, 8a, and 8b. As above, the electronic key 1 in this embodiment is subjected to more than one personal authentications based on the fingerprint data stored when the key 1 is taken out from the key management box 81, the number input with the buttons 7, 8a, and 8b, the electronic key ID, and others. This ensures high security.

The present invention is not limited to the above embodiments and may be embodied in other specific forms without departing from the essential characteristics thereof.

(1) In the above embodiments, the circuitry is changed by use of the first and second switch circuits 14 and 15. As an alternative, the circuitry may be changed by use of a durable semiconductor instead of the' first and second switch circuits 14 and 15.

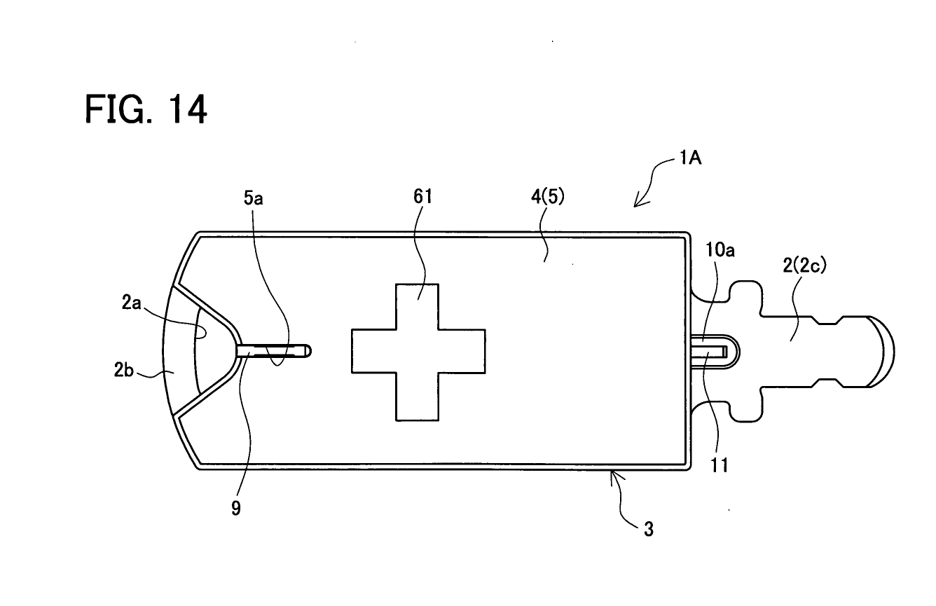

(2) In the above embodiments, the command button 7 and the setting input buttons 8 constitute the PI information input means 22c. An alternative is to configure an electronic key 1A as shown in FIG. 14 such that the IC unit 3 is provided with a cross-shaped key switch 61 (one example of the button) is provided as the PI information input means 22c. In this case, for example, upper, lower, right, and left buttons may be used as the setting input buttons and a central button may be used as a command button. This configuration can provide complicated combinations of button operations for setting the “PI information” and hence prevent a third person from stealing the “PI information” by taking a surreptitious glance at hand motions of an owner of the electronic key.

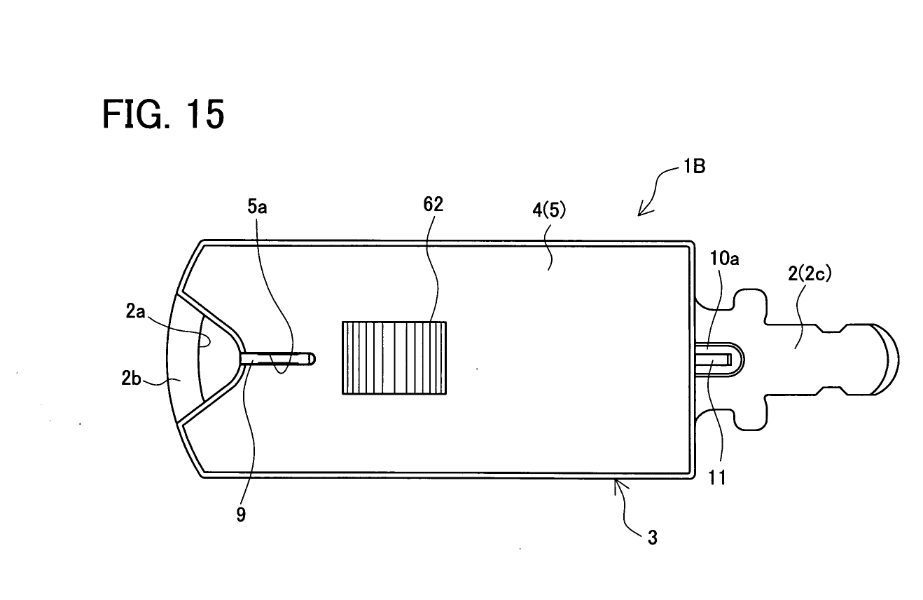

Another alternative is to provide an electronic key 1B as shown in FIG. 15 configured such that the IC unit 3 is provided with a jog dial 62 which is one example of the button for inputting the PI information of an owner of the electronic key. For instance, the jog dial 62 is pressed to command the start of input, the jog dial 62 is repeatedly turned in a predetermined number of times in normal and reverse directions to input the “PI information”, and then the jog dial 62 is pressed to command the end of input. With this configuration, the owner of the electronic key 1B needs only small motion to input the “PI information”, which is unlikely to be stolen by a third person.

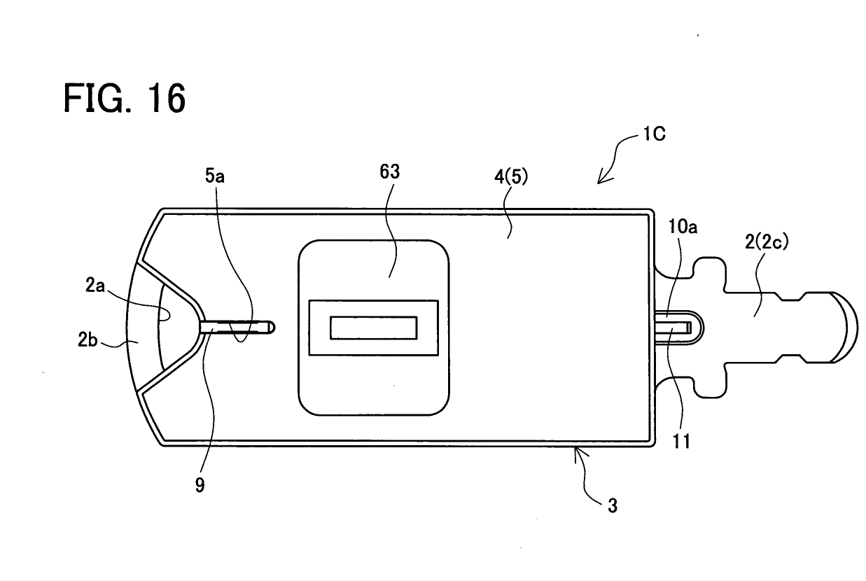

Still another alternative is to provide an electronic key 1C as shown in FIG. 16 configured such that the IC unit 3 is provided with a fingerprint reader 63 is provided as the PI information input means 22c. In this case, an owner of the electronic key 1C can input the “PI information” by sliding a registered finger on the fingerprint reader.

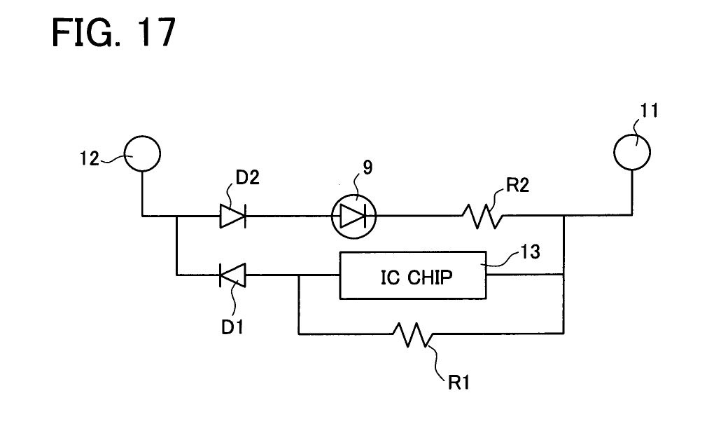

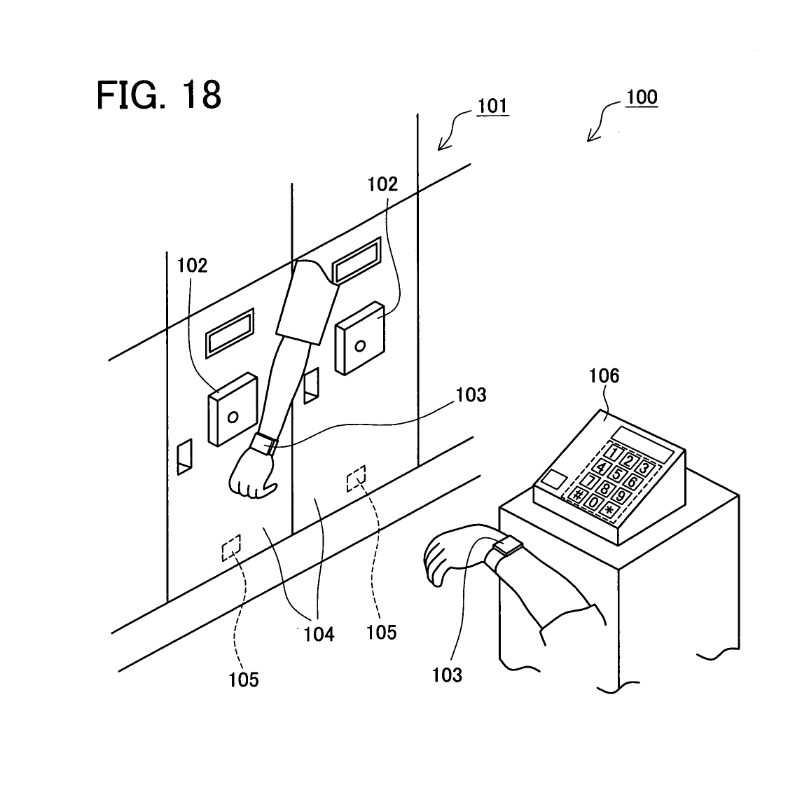

(3) The electronic circuitry of the electronic key 1 explained in the above embodiments may be changed to a circuitry shown in FIG. 17. An electronic key including the electronic circuit shown in FIG. 17, differently from the electronic circuit (see FIG. 7) of the electronic keys in the above embodiments, is configured such that a first resistor R1 is connected in parallel with the IC chip 13. In even the electronic circuit shown in FIG. 17, when a first terminal 11 is positive and a second terminal 12 is negative, a current flows in the IC chip 13 and a first rectifier diode D1, so that the IC chip 13 reads and writes data. When the polarities of the first and second terminals 11 and 12 are switched, an LED 9 is lit up.

(4) In the above embodiments, the electronic key 1 contains the contact IC chip 13. Alternatively, a non-contact IC chip may be used in the electronic key.

(5) In the above embodiments, while the lock 20 of each storage cabinet 51, 52, and 53 is released from a locked state caused by the solenoid 46, the lock 20 is rotated together with the electronic key 1 to lock and unlock. Alternatively, it may be arranged such that when the authority is authenticated based on an electronic key ID of the electronic key 1, an electronic lock is locked or unlocked only by drive of a motor and a solenoid without rotating the electronic key 1.

(6) In the above embodiments, the locks 20 are individually attached to the storage boxes of the storage cabinets 51, 52, and 53 when manufactured. Alternatively, a rim lock integrally including a lock 20 and a lock control means 40 is attached to each storage box after manufacture to permit the electronic key 1 to lock and unlock the rim lock.

(7) In the above embodiments, the IC chip 13 is driven by the battery 17 as a power supply. As an alternative, a condenser may be provided in the IC chip substrate 10 to store electricity while the electronic key 1 is connected to the lock 20 or the key management box, and drive the IC chip 13 by the electricity stored in the condenser. In this case, when the electricity stored in the condenser runs out, the PI information cannot be input. This restricts the period of time or the number of times the PI information can be input in the electronic key ID from the insertion of the electronic key 1 in the lock 20. Security can therefore be enhanced.

(8) In the second embodiment, the access right stored in the electronic key 1 is rewritten by use of the data rewriting system 70. An alternative is to decide a changed “electronic key ID” and changed “PI information” on the host computer 78 side and overwrite them on the electronic key 1.

(9) In the second embodiment, the network 77 is used as one example of the communication line. A wireless communication such as infrared communication may also be used.

(10) Avoidance of the positional limit and the time limit of personal authentication may be achieved as follows. For instance, even though it goes counter to the subject matters of the invention that provides an authentication function to the electronic key 1 itself, an electronic key 1 is connected to a mobile terminal such as a cell phone and the personal identification information is input by use of a control part of the cell phone to cause the cell phone to perform personal authentication of the electronic key 1 and thereby validate or invalidate the electronic key 1.

(11) The electronic key 1 may be used in office furniture such as desks and doors other than the storage cabinets, and other items.

(12) In the above embodiments, the electronic key 1 is configured to cause a current to flow in the IC chip 13 and the LED 9 in opposite directions, but may be configured to cause a current to flow in the IC chip 13 and the LED 9 in the same direction.

(13) In the above embodiments, the first terminal 11 and the second terminal 12 are placed in insulating relation on both sides of the insert element 2. An alternative is to use the insert element 2 itself as the second terminal and attach a plate-like first terminal to the insert element 2 in insulating relation. In this case, the first terminal may be attached to the insert element 2 in intersecting relation to protrude from both sides of the insert element 2 to easily contact with electrodes of a switch circuit.

1. A storage cabinet with key comprising: an electronic key including an electronic key ID memory means for storing an electronic key ID; a storage box for storing an item to be kept; an opening and closing permission means for permitting opening and closing of the storage box; and an opening and closing control means for causing the opening and closing permission means to permit opening and closing of the storage box when the control means reads the electronic key ID and authenticates an authority thereof,
wherein the electronic key includes:
one or more than two buttons;
a personal identification information memory means for registering specific details of operating the one or more than two buttons as a specific personal identification information; and
an electronic key validating and invalidating means for checking the personal identification information input by operation of the one or more than two buttons against the specific personal identification information registered in the personal identification information memory means, and validating the electronic key when the input personal identification information is inconsistent with the specific personal identification information or invalidating the electronic key when the input personal identification information is inconsistent with the specific personal identification information.

2. The storage cabinet with key according to claim 1, wherein
the electronic key validating and invalidating means includes:
a validity condition determining means for determining whether or not a valid period of time to maintain a valid state of the electronic key or a valid number of times in which the validated electronic key can be used is over; and
an electronic key access permitting means for permitting access to the electronic key ID memory means when the validity condition determining means determines that the valid period of time or the valid number of times is not over.

3. The storage cabinet with key according to claim 1, wherein internal data of the electronic key is rewritten by a mobile terminal connected to a host computer through a communication line.

4. An electronic key to be used in the storage cabinet with key set forth in claim 1.

5. An electronic key containing an IC chip, the electronic key comprising:
one or more than two buttons;
a personal identification information memory means for registering specific details of operating the one or more than two buttons as a specific personal identification information; and
an electronic key validating and invalidating means for checking the personal identification information input by operation of the one or more than two buttons against the specific personal identification information registered in the personal identification information memory means, and validating the electronic key when the input personal identification information is consistent with the registered personal identification information or invalidating the electronic key when the input personal identification information is inconsistent with the registered personal identification information.

6. The storage cabinet with key according to claim 1, wherein the button is a push type or a dial type.

7. The storage cabinet with key according to claim 1, wherein the electronic key includes a battery, and
the electronic key validating and invalidating means is driven by the battery as a power supply.

8. The electronic key according to claim 5, wherein the button is a push type or a dial type.

9. The electronic key according to claim 5, wherein the electronic key includes a battery, and
the electronic key validating and invalidating means is driven by the battery as a power supply.

10. The storage cabinet with key according to claim 2, wherein internal data of the electronic key is rewritten by a mobile terminal connected to a host computer through a communication line.

11. An electronic key to be used in the storage cabinet with key set forth in claim 2.

12. An electronic key to be used in the storage cabinet with key set forth in claim 3.
